(19) United States
(12) Patent Application Publication
(10) Pub. No.: US 2010/0148550 A1
(43) Pub. Date: Jun. 17, 2010

(54) AUDIO HEADREST FOR ATTACHMENT TO A SEAT OF A VEHICLE

(75) Inventor: Douglas M. Kidd, Swartz Creek, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., DETROIT, MI (US)

(21) Appl. No.: 12/332,406

(22) Filed: Dec. 11, 2008

(51) Int. Cl. B60N 2/48; A47C 7/72; H04B 1/00; A47C 7/38

(52) U.S. Cl. 297/217.4; 297/397; 381/86

(57) ABSTRACT

An audio headrest attaches to a seat back of a seat assembly in a vehicle. The audio headrest is removably attached to the seat back of the seat assembly and supports a user's head when the user is seated on the seat while supplying audio to the user of the vehicle. The audio headrest includes at least one speaker, a receiver, and an attachment mechanism to attach to the seat back of the seat assembly. The speaker projects audio to the user. The receiver receives a signal from a source, such as a DVD player, a radio, etc. The attachment mechanism attaches the audio headrest to the seat in the vehicle.

### TECHNICAL FIELD

The present invention relates to an audio headrest for a seat in a vehicle.

### BACKGROUND OF THE INVENTION

Many vehicles are equipped with rear seat entertainment and/or rear seat audio systems that allow users of the vehicle to watch movies on a DVD player, play video games, and/or listen to other select sources of audio. These vehicles come equipped with wired or wireless headphones that project the audio to the users in the rear seats of the vehicle. Many of the rear seat systems only work with the headphones or are only played through the vehicle's rear speaker system. Some users of the rear seat entertainment and/or rear seat audio systems may have difficulty fitting the headphones to their heads or find the headphones to be uncomfortable. Additionally, when the vehicle's rear speaker system is projecting the audio, users may be subjected to two different audio tracks simultaneously.

### SUMMARY OF THE INVENTION

An audio headrest is provided for attachment to a seat assembly in a vehicle. The audio headrest supports a user's head when the user is seated on the seat assembly. The headrest includes at least one speaker, a receiver, and an attachment mechanism. The speaker projects audio to the user. The receiver receives a signal from a source. The attachment mechanism attaches the audio headrest to the seat in the vehicle.

A method of providing audio to a user of a vehicle includes providing an audio headrest for a seat of the vehicle. At least one speaker is integrated in the audio headrest. The audio headrest is attached to the seat of the vehicle. The speaker is in electrical communication with the vehicle for supplying power to the speakers and to provide the audio to the user through the audio headrest.

A seat assembly is provided for a vehicle and includes a seat back and an audio headrest. The seat back extends generally vertically between a bottom end and a top end to physically support a back of a user of the vehicle. The audio headrest is attached to the top end of seat back to physically support a head of the user of the vehicle. The audio headrest includes a housing, at least one speaker, a receiver, and an attachment mechanism. The speaker projects audio to the user of the vehicle. The speaker is disposed within the housing. The receiver, which may be disposed within the housing, receives a signal from a source. The attachment mechanism extends from the housing to removably attach the audio headrest to the top end of the seat back.

A wireless headrest speaker system may be a direct replacement for the typical headrest within the vehicle. The wireless headrest speaker system would allow the users that are seated in the back seat of the vehicle to watch movies, play games, and/or only listen to music with minimal disturbance of the users of the front seat of the vehicle. In addition, this provides a solution when more sets of headphones are needed than are supplied with the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Referring now to the figures, which are exemplary embodiments and wherein like elements are numbered alike:

FIG. 1 is a fragmentary rear view of an interior of a vehicle including a vehicle entertainment system and a plurality of front and rear seat assemblies with an audio headrest on each of the rear seat assemblies; and

FIG. 2 is a front view of the audio headrest for the rear vehicle seat assembly.

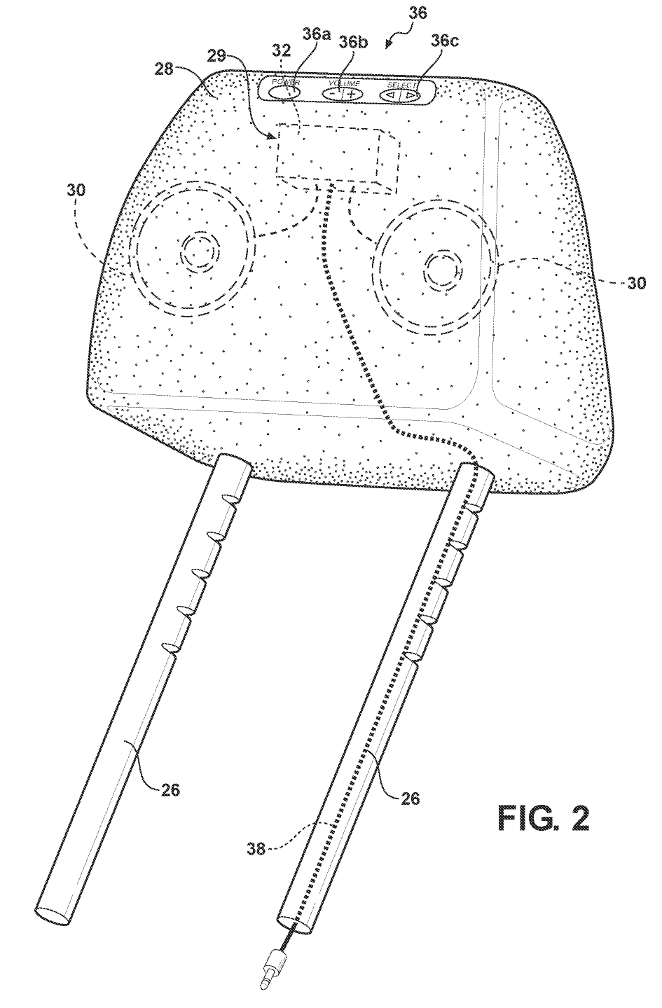

### DESCRIPTION OF THE PREFERRED EMBODIMENTS

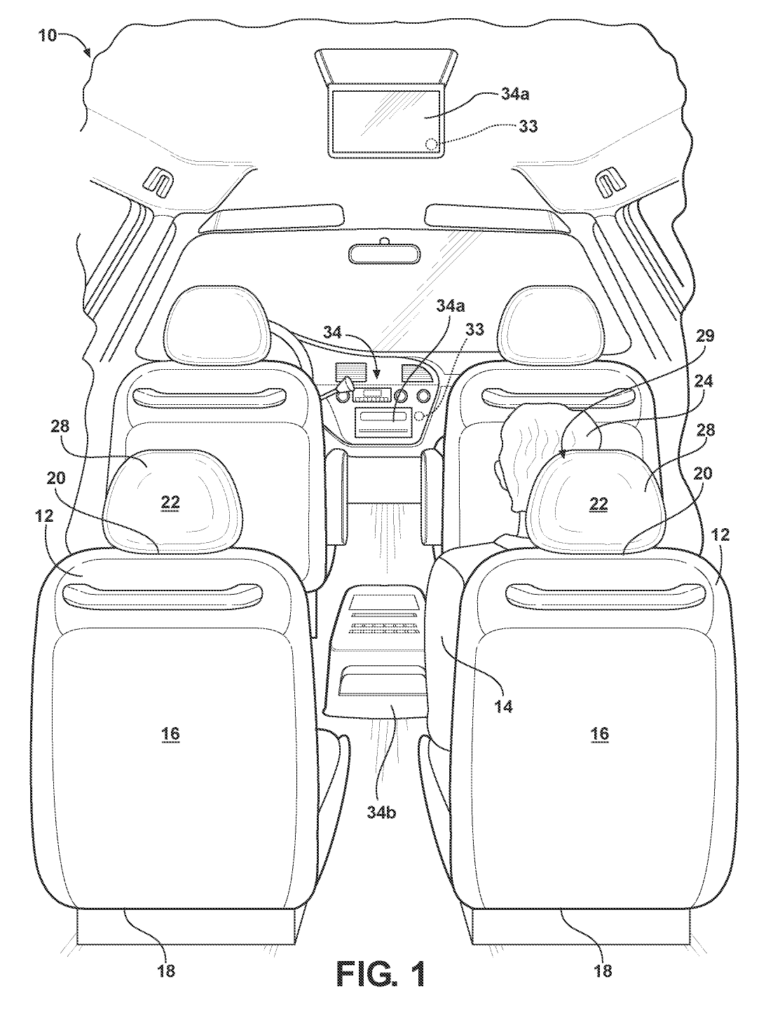

Referring to the drawings, wherein like reference numbers refer to like components, FIG. 1 shows a vehicle 10 having a plurality of seat assemblies 12 for a user 14 to sit upon. At least one of the seat assemblies 12 includes a seat back 16 that extends generally vertically between a bottom end 18 and a top end 20 for supporting a back of the user 14. An audio headrest 22 is attached to the top end 20 of the seat back 16 for physically supporting the head 24 and/or neck of the user 14. The audio headrest 22 may be removably attached to the seat back 16 via an attachment mechanism 26.

The audio headrest 22 is for supporting a user's 14 head 24 when the user 14 is seated on the seat assembly 12. The audio headrest 22 includes a housing 28. One or more speakers 30 may be disposed within the housing 28 for projecting audio to the user 14. The housing 28 may be fabric, leather, vinyl, or any other material known to those skilled in the art for covering the audio headrest 22 for a vehicle 10. The speakers 30 may also be mounted to the exterior of the audio headrest 22 such that the speakers 30 are on a surface 29 of the housing 28. A receiver 32 may be disposed within the housing 28 for receiving a signal from a transmitter 33 within an audio source 34. The receiver 32 is operatively connected to the speakers 30 which translates the signal to produce sound through the speakers 30. The attachment mechanism 26 allows for removable attachment of the audio headrest 22 to the top end 20 of the seat back 16 of the seat assembly 12 in the vehicle 10. It should be appreciated that any attachment mechanism 26 known to those skilled in the art may be used for attaching the audio headrest 22 to the seat back 16 of the seat assembly 12.

The user 14 of the vehicle 10 may decide to configure the vehicle 10 to provide audio through one or more audio headrests 22 in the rear seat assemblies 12 of the vehicle 10. For example, the user 14 may remove a non-audio headrest, i.e., does not have speakers 30, from the seat back 16 of the vehicle 10 seat assembly 12. Next, the user 14 may attach the audio headrest 22 to the top end 20 of the seat back 16 of the seat assembly 12 via the attachment mechanism 20 to both physically support to the head 24 and/or neck of the user 14 and supply audio to the user 14.

The audio headrest 22 may also include a power cord 38. The power cord 38 connects the audio headrest 22 to an electrical power system (not shown) within the vehicle 10 for supplying power to the receiver 32 and/or the speakers 30. The power cord 38 may be routed interiorly through one of the attachment mechanisms 26. This type of routing of the power cord 38 may help to keep the power cord 38 hidden. However, it should be appreciated that any other routing of the cord 38 known to those skilled in the art may also be used. The audio headrest 22 is mechanically and electrically connected to the seat back 16 of the seat assembly 12. Therefore, the audio headrest 22 supplies support to the head 24 of the user 14 and also supplies audio to the user 14, as desired. The audio headrest 22 may be any type of headrest known to those skilled in the art for supporting the head 24 and/or neck of the user 14. As described above, the audio headrest 22 may be attached to the top end 20 of the seat back 16 of the seat assembly 12. The audio headrest 22 may also be adjustably attached to the top end 20 of the seat back 16 of the seat assembly 12 for raising, lowering, and/or tilting the audio headrest relative to the seat back 16 of the seat assembly 12.

The receiver 32 may be an infrared receiver 32 for receiving an infrared signal from the audio source 34. Therefore, the transmitter 33 within the audio source 34 would correspondingly be infrared. However, it should be appreciated that the receiver 32 is not limited to being infrared. For example, the transmitter 33 and/or receiver 32 may be configured to be hard-wired between one another, Bluetooth, or any other transmitter 33/receiver 32 combination known to those skilled in the art from transmitting and receiving an audio signal.

The audio headrest 22 may also include a plurality of selector buttons 36 for controlling the audio through the speakers 30. The plurality of selector buttons 36 may include, but are not limited to, a power selector 36a, a volume selector 36b, and/or an audio source selector 36c. The power selector 36a is for allowing the user 14 to move the receiver 32 between an on position and an off position to control sound coming from the speakers 30. The volume selector 36b is for allowing the user 14 to change a volume of the audio projected through the speakers 30 within the audio headrest 22. The audio source selector 36c is for allowing the user 14 to select from a plurality of the audio sources 34.

The audio sources 34 may be between one or more vehicle manufactured entertainment systems, such as DVD systems 34a and/or rear seat audio (RSA) systems 34b. For example, there may be a plurality of DVD systems 34a within the vehicle 10 and the source selector 36c allows the user 14 to select from one of the plurality of DVD systems 34a. The RSA system 34b may allow the user 14 to independently select from a DVD player, an am/fm radio, a CD player, and the like. The audio sources 34 may also include after-market sources with infrared technology such as, DVD players, MP3 players, CD players, video games, and the like. It should be appreciated, however, that other audio sources 34 may also be selected as known to those skilled in the art.

While the best modes for carrying out the invention have been described in detail, those familiar with the art to which this invention relates will recognize various alternative designs and embodiments for practicing the invention within the scope of the appended claims.

1. An audio headrest for attachment to a seat assembly in a vehicle for supporting a user's head when the user is seated on the seat assembly, said headrest comprising:
at least one speaker for projecting audio to the user;
an infrared receiver for receiving an infrared signal from an infrared transmitter of a source; and
an attachment mechanism for attaching said audio headrest to the seat in the vehicle.

2. (canceled)

3. (canceled)

4. An audio headrest, as set forth in claim 1, further comprising a power selector for allowing the user to move said infrared receiver between an on position and an off position.

5. An audio headrest, as set forth in claim 1, further comprising a volume selector for allowing the user to change a volume of the audio projected through said at least one speaker.

6. An audio headrest, as set forth in claim 1, further comprising a source selector for allowing the user to select from a plurality of said sources.

7. An audio headrest, as set forth in claim 6, wherein said plurality of said sources is at least one of a DVD system and a rear audio system.

8. An audio headrest, as set forth in claim 7, wherein said DVD system is a plurality of DVD systems.

9. An audio headrest, as set forth in claim 1, further comprising a power cord for supplying power to at least one of said receiver and said speakers.

10. A method of providing audio to a user of a vehicle, said method comprising:
providing an audio headrest for a seat of the vehicle, wherein at least one speaker and one infrared receiver are integrated in the audio headrest;
attaching the audio headrest to the seat of the vehicle;
electrically connecting the at least one speaker to the vehicle for supplying power to the speakers to provide the audio to the user through the audio headrest;
transmitting an infrared signal from a transmitter in at least one source to an infrared receiver in the audio headrest to project audio through the at least one speaker.

11. A method, as set forth in claim 10, further comprising removing a non-audio headrest from the seat of the vehicle prior to attaching the audio headrest to the seat of the vehicle.

12. (canceled)

13. (canceled)

14. A method, as set forth in claim 10, further comprising operating a power selector to move the infrared receiver between an on position for projecting audio through the at least one speaker and an off position for ceasing audio through the at least one speaker.

15. A method, as set forth in claim 10, further comprising operating a volume selector for changing a volume of the audio projected through the at least one speaker.

16. A method, as set forth in claim 10, further comprising operating a source selector to select from a plurality of the sources.

17. A seat assembly for a vehicle, said seat assembly comprising:
a seat back extending generally vertically between a bottom end and a top end for physically supporting a back of a user of the vehicle;
an audio headrest attached to said top end of seat back for physically supporting a head of the user of the vehicle, said audio headrest including;
a housing,
at least one speaker for projecting audio to the user of the vehicle, wherein said at least one speaker is disposed within said housing,
an infrared receiver for receiving an infrared signal from an infrared transmitter of a source, wherein said infrared receiver is disposed within said housing, and
an attachment mechanism extending from said housing for removably attaching said audio headrest to said top end of said seat back.
